(19) United States
(12) Patent Application Publication
(10) Pub. No.: US 2026/0247327 A1
(43) Pub. Date: Aug. 20, 2026

(54) METHODS FOR DETECTING UNDESIRABLE DEVICES WITH LOCATION TRACKING (DLT) CAPABILITIES IN A MOBILE NETWORK

(71) Applicant: InterDigital Patent Holdings, Inc., Wilmington, DE (US)

(72) Inventors: Mohamad Kenan Al-Hares, Canterbury (GB); Michel Roy, Candiac (CA); Ulises Olvera-Hernandez, Saint-LAZARE (CA); Zhibi Wang, Woodridge, IL (US); Michael Starsinic, Newtown, PA (US); Alec Brusilovsky, Downingtown, PA (US); Samir Ferdi, Kirkland (CA)

(73) Assignee: InterDigital Patent Holdings, Inc., Wilmington, DE (US)

(21) Appl. No.: 19/054,004

(22) Filed: Feb. 14, 2025

(51) Int. Cl. H04W 64/00

(52) U.S. Cl. CPC H04W 64/00

(57) ABSTRACT

A method performed by a WTRU may comprise: detecting a DLT; transmitting, to a network node, a DLT reporting request message including a DDC associated with the detected DLT; receiving, from the network node, a DLT reporting response message, including a DLT status of the detected DLT; and receiving, from the network node, a DLT policy update notification message, including the DLT status and an updated DLT reporting policy associated with the detected DLT. The WTRU may be a sensing WTRU. The network node may be configured with a DLTF. The DLT status may be a desirable state, an undesirable state, or an unknown state.

### BACKGROUND

A sensing wireless transmit/receive unit (WTRU) is a device capable of registering with a mobile network and adhering to defined sensing and/or reporting policies. A sensing WTRU can directly report data from a device with location tracking (DLT) to the network. This reporting can either be done directly to a device location tracker function (DLTF) or to an application function (AF), which then relays the information to the network (e.g., to a DLTF).

A device detection code (DDC) is a unique identifier broadcast by a DLT at a specific frequency. A DLT may broadcast one or more DDCs to announce its presence at a particular location or to communicate specific messages to the network. For example, a DLT may broadcast a specific DDC upon entering a restricted area or when experiencing a technical issue. This information may be detected by nearby sensing WTRUs, which then reports the DDC to the network. The network can use the DDC to identify the corresponding DLT since each DDC is unique. As with any unique identifier, confidentiality and privacy measures may be necessary to protect the DLT's identity.

A DLT is a device that transmits a DDC using low-power radio technology. A sensing WTRU can detect and report the DLT's DDC to the network for further processing.

A DLTF is a function implemented within a mobile network to manage DLT-related information and provide value-added services. The DLTF serves as a unified platform for reporting DLT information, addressing ecosystem fragmentation, and leveraging mobile network capabilities for enhanced functionalities. These functionalities may include precise control over DLT tracking and detecting unauthorized or undesirable DLTs. The DLTF service allows users to register DLTs associated with their subscriptions (e.g., as paying subscribers to the DLTF service). This enables granular management of their registered DLTs, including tracking and detection preferences. The DLTF can be implemented as a network function (NF) or as part of an existing NF, such as the Unified Data Management (UDM) or Unified Data Repository (UDR).

### SUMMARY

A network node may comprise a transceiver and a processor. The transceiver and processor may be configured to: receive, from a first WTRU, a DLT reporting request message including a DDC associated with a detected DLT; determine, based on the DLT reporting request message, an identity of a second WTRU, wherein the second WTRU is within proximity of the detected DLT; determine, based on the identity of the second WTRU and a user profile associated with the second WTRU, a first DLT status of the detected DLT; transmit, to the first WTRU, a DLT reporting response message, including the first DLT status; transmit, to the second WTRU, a DLT detection notification message, including the first DLT status; receive, from the second WTRU, a DLT notification response message, including a second DLT status of the detected DLT; update the user profile with the second DLT status; and transmit, to the first WTRU, a DLT policy update notification message, including the second DLT status. The network node may be configured with a DLTF. The first WTRU may be a sensing WTRU and the second WTRU may be a user WTRU. The first DLT status may be a desirable state, an undesirable state, or an unknown state and the second DLT status may be a desirable state, an undesirable state, or an unknown state.

A WTRU may comprise a transceiver and a processor. The transceiver and processor may be configured to: detect a DLT; transmit, to a network node, a DLT reporting request message including a DDC associated with the detected DLT; receive, from the network node, a DLT reporting response message, including a DLT status of the detected DLT; and receive, from the network node, a DLT policy update notification message, including the DLT status and an updated DLT reporting policy associated with the detected DLT. The WTRU may be a sensing WTRU. The network node may be configured with a DLTF. The DLT status may be a desirable state, an undesirable state, or an unknown state.

A method performed by a WTRU may comprise: detecting a DLT; transmitting, to a network node, a DLT reporting request message including a DDC associated with the detected DLT; receiving, from the network node, a DLT reporting response message, including a DLT status of the detected DLT; and receiving, from the network node, a DLT policy update notification message, including the DLT status and an updated DLT reporting policy associated with the detected DLT. The WTRU may be a sensing WTRU. The network node may be configured with a DLTF. The DLT status may be a desirable state, an undesirable state, or an unknown state.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a service based architecture (SBA);

FIG. 3 illustrates an example procedure for device with location tracking (DLT) provisioning;

FIG. 4 illustrates an example procedure for network detection of undesirable trackers;

FIG. 5 illustrates an example procedure for network detection of undesirable trackers via an associated application function (AF);

FIG. 6 illustrates a flow chart of an example procedure performed by a network node for detection of undesirable trackers; and

FIG. 7 illustrates a flow chart of an example procedure performed by a WTRU for detection of undesirable trackers.

### DETAILED DESCRIPTION

The following acronyms and abbreviations may be referred to:
AF Application Function
AMF Access and Mobility Management Function
AN Access Network
BLE Bluetooth Low Energy
CN Core Network
DDC Device Detection Code
DLT Device with Location Tracking
DLTF Device Location Tracker Function
GNSS Global Navigation Satellite System
GPS Global Positioning System
GUI Graphical User Interface
NF Network Function
NFC Near Field Communication
PCF Policy Control Function
RAN Radio Access Network
RF Radio Frequency
RFID Radio Frequency Identification
SBA Service Based Architecture
SBI Service Based Interface
SCP Service Communication Proxy
SUCI Subscription Concealed Identifier
SUPI Subscription Permanent Identifier
UDM Unified Data Management
UDR Unified Data Repository
UE User Equipment
UWB Ultra-wideband
WiFi Wireless Fidelity
WTRU Wireless Transmit/Receive Unit

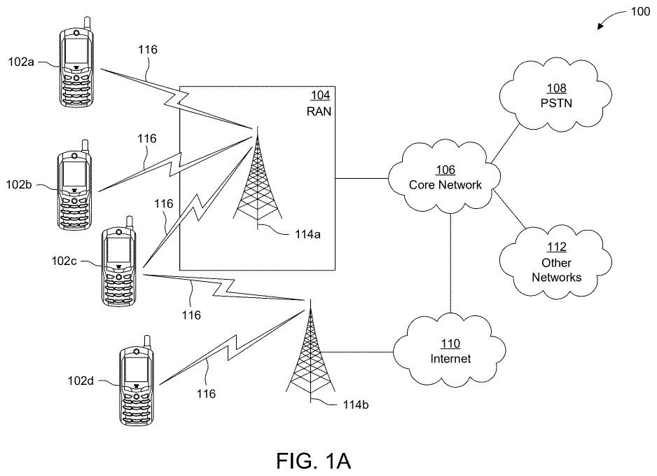

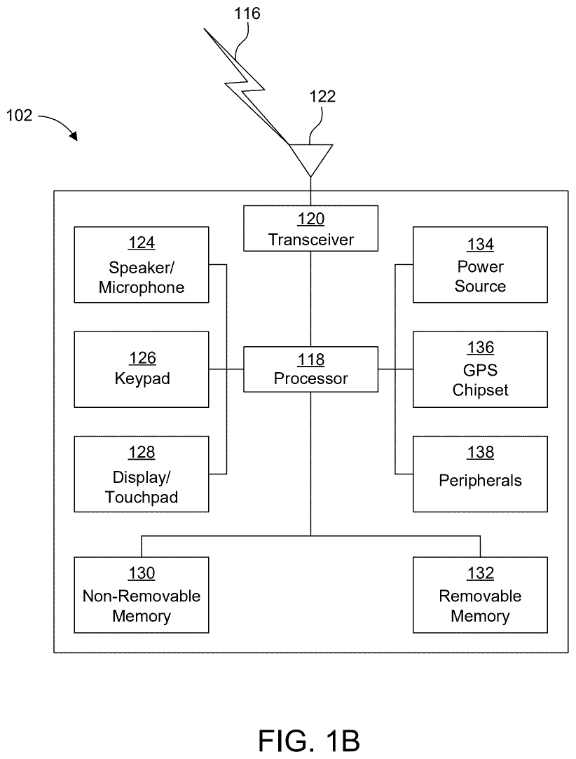

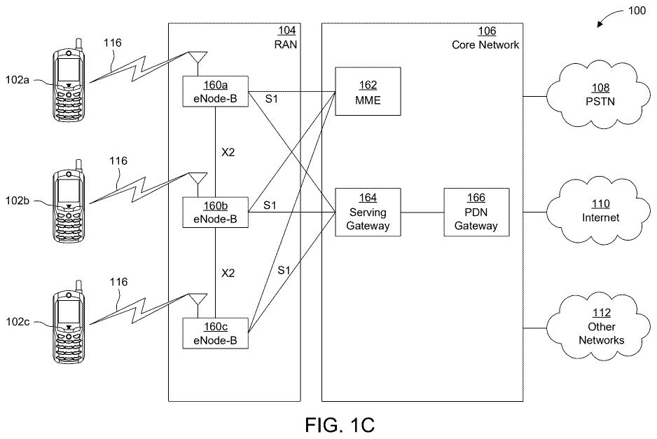

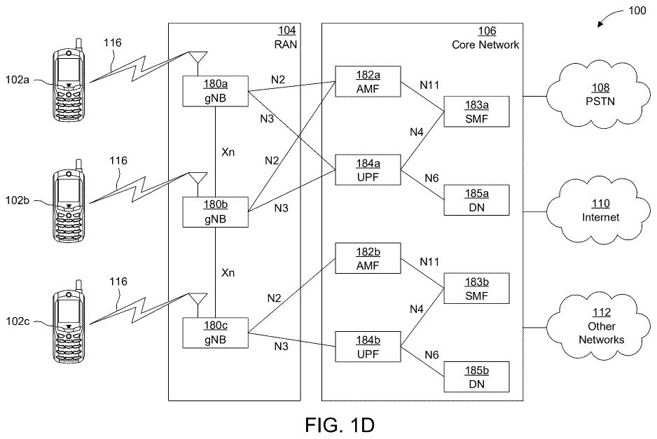

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Tag tracking technologies involve various methods used to monitor and locate objects or individuals through specialized tags. These technologies are applied across multiple domains, including supply chain management and personal tracking, offering solutions for different tracking requirements.

One tracking technology is GPS and GNSS based tracking. GPS and GNSS use satellite signals to determine precise locations. GPS and GNSS are widely used in fleet management, personal tracking, and other outdoor applications where accurate location data is essential.

Another tracking technology is BLE beacon tracking, which is often used for personal tracking and proximity-based applications. This technology is integrated into consumer devices allowing users to track items within a short-range using Bluetooth signals.

Another tracking technology are smart tags, which provide tracking capabilities by integrating various sensors. This technology is often used in industries like cold-chain logistics and industrial asset tracking.

Another tracking technology is WiFi-based tracking, which determines the location of connected devices by analyzing signal strength and triangulation techniques. This method is particularly effective for indoor tracking, where GPS signals may be weak or unavailable. WiFi-based tracking may be used for monitoring people and assets within enclosed environments, such as office buildings, warehouses, and shopping centers.

Different tracking technologies are suited to different use cases. For proximity-based or asset tracking, RFID, BLE, and NFC provide efficient solutions. When outdoor or high-precision tracking is required, GPS and Ultra-Wideband (UWB) offer accurate location data. In indoor environments, WiFi, Zigbee, and/or infrared technologies provide reliable tracking.

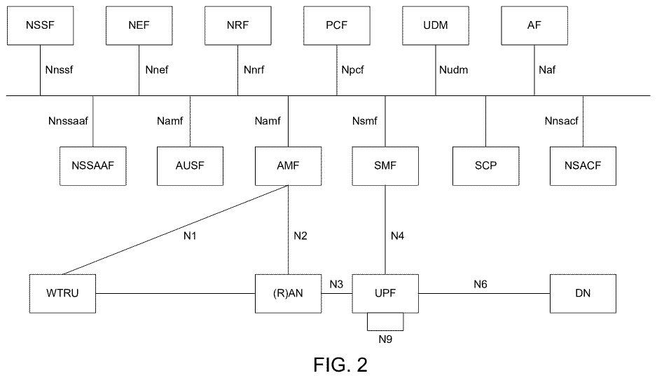

FIG. 2 illustrates a service based architecture (SBA). In SBA, the 5G Core network is structured as a set of network functions (NFs), where each NF represents a control plane functionality or a data repository. This architecture separates control plane and user plane functionalities, providing greater flexibility in deploying the core network in centralized or distributed configurations.

Network functions may communicate and exchange information using the HTTP protocol over a service communication proxy (SCP), which acts as an intermediary HTTP node, optimizing and managing service-based communications. Additionally, SBA supports unified authentication architecture for 3GPP and non-3GPP network access and maximizes the 5G core benefits from different cloudification and virtualization techniques.

A DLT generally relies on nearby WTRUs to detect its presence and report the locations where the sensing occurs. However, DLTs have several characteristics and limitations that impact their functionality and effectiveness.

One limitation is that DLTs operate with limited power and minimal RF capabilities, which restrict their communication range and efficiency. Additionally, DLT solutions may be confined to specific WTRUs, applications, and operating systems within a particular DLT ecosystem, limiting their ability to be universally sensed and tracked.

Furthermore, the ecosystem constraints may limit the variety of DLT and WTRU combinations that can interwork, restricting the range of possible use cases. For example, industrial and logistics applications may involve equipment from multiple manufacturers, each incorporating different built-in DLTs that belong to distinct ecosystems, making seamless integration difficult.

Another significant limitation is that DLT owners have no control over whether their DLTs can be tracked or not. Once a DLT is sensed by a nearby WTRU within the ecosystem, it is automatically reported, with no option for the owner to regulate or restrict this process. Additionally, detecting undesirable DLTs that may be used for unauthorized tracking of users or equipment is challenging to prevent. Because DLT sensing and reporting occur passively within the ecosystem, it is difficult to identify and mitigate potential privacy or security risks associated with unwanted tracking.

As DLTs become more widely adopted, it is important to address existing DLT limitations while also enabling new capabilities. Mobile networks can play a crucial role in overcoming these challenges and enhancing DLT functionality. For instance, advancements in mobile network capabilities can mitigate issues related to the fragmented DLT ecosystem by providing standardized solutions. Additionally, mobile networks can introduce new features for users, such as the ability to control DLT sensing and reporting and detect undesirable DLTs through sensing devices and the network. These enhancements can also create new revenue opportunities for mobile network operators.

The following embodiments provide capabilities that enable a mobile network (e.g., cellular network) to track DLTs by leveraging surrounding devices connected to the network. These enhancements provide functionalities for both DLTs and the mobile network, including the ability to track DLTs more effectively, implement granular control over DLT tracking, and enhance detection mechanisms. For example, these capabilities allow for the management of undesirable DLTs, thus improving security and control within the network.

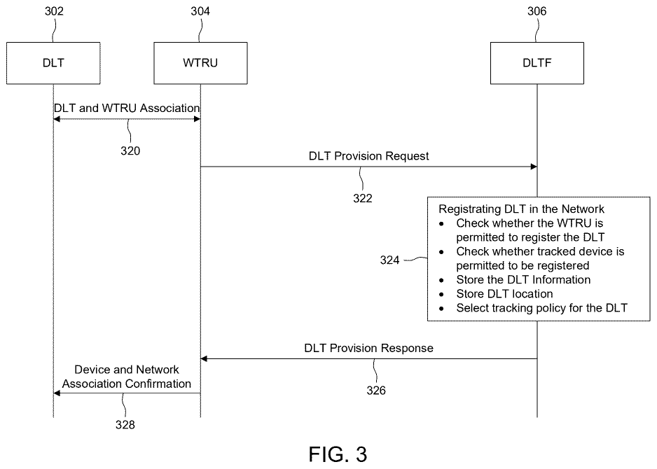

FIG. 3 provides an exemplary procedure 300 for DLT and device association provisioning. Procedure 300 may be used to associate a DLT with a user device, such a WTRU.

At 320, the DLT 302 and WTRU 304 are associated. The association between the DLT 302 and the WTRU 304 may be established using either non-pairing or pairing methods. If the DLT does not support pairing technologies, an association can be achieved through a portal-based method. Alternatively, if pairing is supported, the DLT 302 may be linked to the WTRU 304 using pairing technologies, such as Bluetooth. Alternatively, the association procedure may involve the DLT 302 broadcasting a temporary identifier, which may include a manufacturer/application ID along with a randomly generated DLT association identifier created by the DLT 302 during the association process. This temporary identifier may then be utilized by the WTRU 304 to initiate the provisioning request.

The association process may involve the exchange of identities between the DLT 302 and the WTRU 304. During this process, the WTRU 304 may use a temporary identifier, such as a WTRU association identifier, to enable communication with the DLT 302 for the duration of the association procedure. The DLT identity may be assigned either statically by the manufacturer or dynamically by a NF, such as the UDR. The DLT identity may serve as a unique device identifier, which is stored within a NF, such as the UDR for 3GPP device identity management. Additionally, the DLT identity may be associated with the WTRU subscriber record in the UDM system and may be provisioned to the DLT during the provisioning procedure described at 326 below. The use of the temporary identifier may also be helpful for privacy protection of the unique identifier.

The association may include DLT 302 sharing its power level with the WTRU 304. The power level may assist the DLTF 306, when receiving the association request from the WTRU 304, to decide association roles, such as association length. The association may also include the DLT 302 sharing its location information with WTRU 304. The association may also include the DLT 302 and WTRU 304 exchanging radio capabilities such as frequency and range. The association may also include the DLT 302 and WTRU 304 exchanging the available pairing technologies specifications.

At 322, the WTRU 304 may send a DLT provisioning request message to the DLTF 306. The WTRU 304 may send the DLT provisioning request over a SBI. The provisioning request message may include the identity of the WTRU 304, such as SUCI or SUPI, and also the DLT ID, such as a DLT serial number or a DDC. The DDC may be sent to the network as part of the DLT provisioning procedure and an association may be performed between the DLT 302, DDC, and WTRU identifiers.

The provisioning request message may also include a DDC for the DLT 302. The DDC may serves as a unique identifier or set of identifiers assigned to each DLT. A DLT may broadcast one or more DDCs, meaning that a single DLT may be associated with multiple detection codes. These DDCs may be detected by surrounding sensing WTRUs, which may then report or transmit the detected codes to the network.

The provisioning request message may also include location information for the DLT 302 and/or the WTRU 304. This location data may include the movement trajectories of either the DLT 302 and/or the WTRU 304.

The provisioning request message may also include association information, which may provide details such as the association period, association location, and association technology type (e.g., Bluetooth). Additionally, the association information may indicate the reason for association (e.g., tracking purposes) and identify any associated applications, meaning whether the association is requested, managed, or linked to specific applications.

At 324, after receiving the provisioning request from the WTRU 304, the DLTF 306 may check the privileges of the WTRU 304 and whether the WTRU 304 is permitted to be associated.

For example, the DLTF 306 may check if the WTRU 304 is permitted to track DLT devices. The DLTF 306 may check if the WTRU 304 is permitted to track certain DLT IDs. The DLTF 306 may check if the WTRU 304 is permitted to track the targeted DLT at the current WTRU 304 or DLT location. The information regarding DLT and WTRU 304 tracking permissions may be available in the UDM/UDR. The DLTF 306 may retrieve this information from UDM/UDR and decide accordingly.

For example, The DLTF 306 may check if the DLT 302 is allowed to be associated with the WTRU 304. The DLTF 306 may check if the WTRU 304 is permitted to be associated with specific DLT. The DLTF might check if the DLT is permitted to associate with the WTRU 304 in the current location or time.

For example, the DLTF 306 may verify whether the reason for the association is allowed or valid. For instance, if the association is requested for DLTF tracking, the DLTF 306 may check whether the DLT 302 is permitted to be tracked in the given location or whether the WTRU 304 is permitted to track the DLT 302 at that location.

Additionally, the DLTF 306 may determine whether the DLT 302 is already associated with another sensing WTRU and assess whether multiple associations with different sensing WTRUs are permitted for the DLT 302.

If the association is approved, the association policy between the DLT 302 and the WTRU 304 may be stored in the PCF or in the UDM/UDR. The association policy may include association roles along with reporting and tracking policies.

At 326, in response to the DLT provisioning request message at 322, the DLTF 306 may send a DLT provision response message to the WTRU 304. This DLT provision response message may indicate whether the association is permitted and include details regarding association roles and the tracking policy. The association roles may define parameters such as the duration of the association between the WTRU 304 and the DLT 302, the locations where the association is allowed, the locations where tracking of the DLT is permitted, and an association identifier.

The tracking policy may include the permitted actions that the sensing WTRU and the network may take to track and monitor the DLT 302 and its surroundings. For example, if the sensing WTRU loses connectivity or is unable to accurately determine the location of the DLT 302, it may request assistance from the network to locate the DLT 302. In such cases, the network, through the DLTF 306 or another relevant function, may activate nearby sensing WTRUs that have previously detected the DLT 302, prompting them to report relevant information, such as the DLT's current location, back to the network.

The tracking policy may also specify whether a sensing WTRU is allowed to scan for surrounding DLTs and report any suspicious DLTs to the network. The network policy may define whether tracking for a DLT can be activated, disabled, or paused. Based on this network policy, the sensing WTRU may, for example, pause reporting its location for a certain period or in a specific location, or disable reporting the DLT location to the network permanently. The tracking policy may also allow the sensing WTRU to request the DLT 302 to stop broadcasting its DDC or to cease transmitting location information.

The provisioning response message may also include information about AFs that are permitted to associate with a DLT. This AF information may include an AF identifier and an AF endpoint, such as a URI, URL, or IP address.

At 328, after receiving the network response, the sensing WTRU may finalize the association with the DLT 302. This association may generate a credential, which can be created either by the sensing WTRU alone or collaboratively by both the sensing WTRU and the DLT. This credential is then stored by both the DLT and the sensing WTRU for future authentication or ownership verification. To facilitate credential generation, the sensing WTRU may either transmit a parameter to the DLT, enabling it to generate the credential, or communicate the encrypted credential directly to the DLT 302.

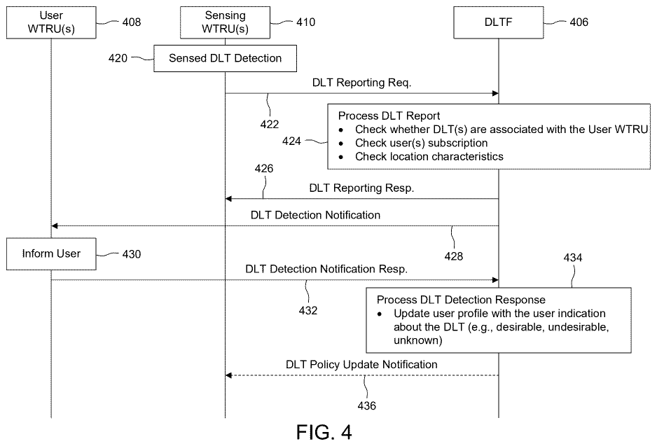

FIG. 4 provides an exemplary procedure for network detection of undesirable trackers near registered users and/or devices. In the procedure described in FIG. 4, the User WTRU 408 and the Sensing WTRU 410 may be the same WTRU and the procedures and processing performed by the Sensing WTRU 410 may be performed by the User WTRU 408. The DLTF 406 may reside within a network node (e.g., the network node may be configured with a DLTF).

At 420, the Sensing WTRU 410 may detect one or more nearby DLTs. This detection process may involve the Sensing WTRU 410 scanning for surrounding radio waves to identify signals emitted by a DLT. Upon detecting a signal, the sensing WTRU may extract a DLT identifier from the transmitted signal. For example, the DLT may broadcast a DDC, which can be detected by the Sensing WTRU 410 and subsequently reported to the network.

The Sensing WTRU 410 may compile a list of detected DLTs over a period of time and report this list to the DLTF 406 at predefined intervals based on a configured time period. Additionally, the Sensing WTRU 410 may detect any omitted DDCs from the DLTs.

At 422, the Sensing WTRU 410 may send a DLT reporting request message to the DLTF 406. The DLT reporting request message may include the following information about one or more detected DLT.

The DLT reporting request message may include a first information element, which may include the sensed DDC for each detected DLT. The DDC may be an identifier that is configured in the DLT and that is broadcast by a DLT over a radio signal. The DDC may uniquely identify a DLT, but may not provide the Sensing WTRU 410 with any information about the owner of the DLT.

The DLT reporting request message may include a second information element. The second information element may include the DLT detection time information for each detected DLT. The DLT detection time information may indicate the exact time at which a DDC was sensed by the Sensing WTRU 410 and may also indicate the duration for which the DLT remained detectable. The DLTF 406 may utilize this detection time information to determine the location of a sensed DLT and to establish a detection timeline or detection history.

The DLT reporting request message may include a third information element. The third information element may include the location information of the Sensing WTRU 410 for each detected DLT. The location information may indicate the exact location of the Sensing WTRU 410 at the time of DLT detection. Additionally, the location information may include the trajectory, speed, orientation, and/or altitude of the Sensing WTRU 410. The DLTF 406 may use this data to help determine the location of a sensed DLT.

The DLT reporting request message may include a fourth information element. The fourth information element may include signal detection information for each sensed DLT. The signal detection information may provide details about the DLT's transmitted signal, including the signal type, technology (e.g., BLE, WiFi), and the frequency used by the Sensing WTRU 410 for detection. Additionally, it may indicate the signal strength of the detected DLT. The DLTF 406 may analyze this signal detection information to assist in determining the location of the sensed DLT.

At 424, after the DLTF 406 receives the DLT reporting request message from the Sensing WTRU 410, it may use the DDC included in the message to identify a registered DLT with the same DDC. The registered DLT information about the registered DLT may be stored in the DLTF 406 or within the UDM/UDR, having been previously registered when a user provisioned the DLTF 406.

If the DLTF 406 identifies a registered DLT, it may store the sensing information from the DLT reporting request message either within the DLTF 406 or in the UDM/UDR, alongside the registered DLT information. If no registered DLT is found with the corresponding DDC, the DLTF 406 may record the DDC along with the sensing information in a list of unregistered DLTs.

For each sensed DLT or detected DDC reported in the DLT reporting request message, the DLTF 406 may aggregate location information, detection time information, and signal strength data from one or more sensing WTRUs 410 to determine the expected position of the associated DLT. This information, which may have been previously reported by one or more sensing WTRUs 410, may be available within the DLTF 406 or stored in the UDM/UDR.

Upon receiving the DLT reporting request message, the DLTF 406 may initiate an analysis of the sensed DLT information included in the request. The analysis may require the DLTF to obtain the identifiers of WTRUs and DLTs that are in proximity of the detected DLT location.

The analysis of the sensed DLT information included in the DLT reporting request message may involve a three step process. First, the DLTF 406 may obtain information about other WTRUs or DLTs that are in proximity to the detected DLT. Second, the DLTF 406 may establish a relationship between the detected DLT and the nearby identified WTRUs or DLTs nearby. Finally, the DLTF 406 may examine historical positioning data to assess whether the detected DLT is considered undesirable.

In the first step of the analysis of the sensed DLT information included in the DLT reporting request message, the DLTF 406 may gather information about other WTRUs or DLTs that are near the detected DLT. For example, the DLTF 406 may identify WTRUs in proximity by utilizing a location management service provided by the network. The location management service allows the DLTF 406 to send a request including the DLT's location and retrieve WTRU identifiers that are within its vicinity. Alternatively, the DLTF 406 may use available DLT location information, either stored within the DLTF 406 or in the UDM/UDR, to identify other DLTs that are in proximity to the detected DLT.

In the second step of the analysis of the sensed DLT information included in the DLT reporting request message, the DLTF 406 may establish a relationship between the detected DLT and the other WTRUs or DLTs identified in the first step as being in proximity of the detected DLT. For example, the DLTF 406 may determine whether the detected DLT is associated with WTRU identifiers or other DLT identifiers nearby by examining the registration information of the detected DLT alongside the registration records of DLTs associated with the WTRUs in proximity.

Similarly, the DLTF 406 may check whether DLTs in proximity of the detected DLT are associated with the User WTRU 408. For example, the DLTF 406 may determine that the detected DLT is linked to a WTRU, which may be the User WTRU 408 or another WTRU in proximity of the detected DLT, if it is a registered DLT with the WTRU or appears in a DLT whitelist associated with the WTRU. Additionally, the DLTF 406 may establish relationships between DLTs by identifying whether the detected DLT is connected to another DLT nearby, either by checking if both DLTs are registered with the same WTRU (which may not be in proximity at that time) or by confirming their presence in a DLT whitelist associated with that WTRU. For example, the DLTF 406 may conclude that a detected DLT is associated with the User WTRU 408 or another DLT, thereby determining that the detected DLT should not be classified as undesirable. Conversely, if the DLTF 406 is unable to establish a relationship between the detected DLT and the User WTRU 408 or another DLT, it may flag the detected DLT as undesirable.

In the third step of the analysis of the sensed DLT information included in the DLT reporting request message, the DLTF 406 may perform a historical analysis of the location data for the detected DLT, as well as for the User WTRU 408 or other DLTs associated with the User WTRU 408 in proximity. This historical analysis may help to establish or confirm whether a detected DLT is undesirable based on the relationships identified in the second analysis step. For example, if the DLTF 406 has already determined that a detected DLT may be undesirable, it may further analyze historical location data to validate this classification. If the DLTF 406 finds that the historical location of the detected DLT closely matches the historical location of a WTRU or another DLT for a specified period, it may confirm that the detected DLT is undesirable.

The outcome of the analysis performed at 424 may result in assigning a status and/or state to the detected DLT. This DLT state may indicate that: (1) the detected DLT is not undesirable (i.e., desirable), (2) the detected DLT is undesirable, or (3) the DLTF 406 is unable to determine whether the detected DLT is undesirable or not.

At 426, the DLTF 406 may send a DLT reporting response message to the Sensing WTRU 410. This response message may provide the status of the DLT reporting request processing along with DLT reporting policy information. For example, the state and reporting policy included in the response may reflect the outcome of the analysis performed at 424.

The DLT reporting policy information may specify the status of the detected DLT (e.g., desirable, undesirable, or unknown) associated with a DDC, along with relevant DLT reporting details. For example, the response may indicate whether the DLT has been classified as desirable, undesirable, or unknown and may also include a modified reporting frequency for the DLT or its associated DDC. This modified frequency may instruct the Sensing WTRU 410 to suspend reporting of DLT or DDC sensing information for a certain period or, conversely, to increase the reporting frequency to enhance monitoring of a specific DLT.

Upon receiving the DLT reporting response message, the Sensing WTRU 410 may modify the sensing and reporting characteristics for one or more DLTs based on the information included in the response. For example, the Sensing WTRU 410 may stop reporting specific DLT locations to the network. In another example, the Sensing WTRU 410 may de-associate from the DLT.

At 428, the DLTF 406 may send a DLT detection notification message to one or more User WTRUs 408. These User WTRUs 408 may include WTRUs in proximity, WTRUs associated with other DLTs identified at 424, or the device owner of the targeted DLT. The DLT detection notification may contain information about one or more DLTs, including certain information elements relevant to the detected devices.

A first information element may include a DLT identifier or DDC, which may serve as a unique identifier for the DLT at the User WTRU 408. This identifier may be used by the User WTRU 408 when transmitting information about the DLT to the DLTF 406. The unique identifier may be a temporary identifier assigned by the DLTF 406 and may be different than the DDC to preserve anonymity of the DLT.

A second information element may include the DLT state determined by the DLTF 406 at 424. This DLT state may informs the User WTRU 408 whether the DLT is classified as desirable, undesirable, or unknown. Based on this classification, the User WTRU 408 may perform different actions.

If the DLT state is undesirable, the User WTRU 408 may provide a visual notification through its GUI, alerting the user that an undesirable DLT has been detected by the network at a specific location. This notification may also prompt the User WTRU 408 to begin tracking the undesirable DLT, allowing the user to locate the undesirable DLT. If the DLT state is unknown, the User WTRU 408 may issue a visual notification through its GUI requesting the user's confirmation on whether the DLT is known and should be classified as undesirable or not.

A third information element may include the current and historical locations of the DLT. This information may allow the User WTRU 408 to locate the DLT and assess whether it should be classified as undesirable.

A fourth information element may include time period information. The time period information may indicate how long the DLT has been associated with its assigned state.

At 430, upon receiving the DLT detection notification message from the DLTF 406, the User WTRU 408 may issue one or more notifications to the user. These notifications may indicate the detection of a DLT, request user input to determine a definitive DLT status, and/or assist the user in locating the detected DLT. If the notification is to request a confirmation from the user about a DLT state, the User WTRU 408 may collect that information from the user, for example via a GUI.

At 432, the User WTRU 408 may send a DLT detection notification response message to the DLTF 406. The DLT detection notification response message may include the DLT state, indicating whether the DLT is undesirable or not. Additionally, the message may provide instructions regarding any further actions the DLTF 406 should take concerning the DLT. For example, the response may indicate that the DLT is undesirable and that the user does not want the network to continue tracking it while it remains in this state. Alternatively, the response may specify that the DLT should be added to the allowed DLT list, instructing the DLTF 406 to classify it as “allowed” in future detections.

At 434, upon receiving the DLT detection notification response message, the DLTF 406 may update the DLT information and status to reflect the dispositions obtained in the DLT detection notification response message. The DLT status may be desirable, undesirable, or unknown. For example, the decision may specify that a DLT is permitted to track the User WTRU 408 or that DLT localization should be blocked for a certain period. This update may be considered by the DLTF 406 in future analyses, as described in 424, and may influence whether to initiate the procedures outlined in 428 to 432 with the User WTRU 408.

For example, if the User WTRU 408 has previously provided a disposition for a DLT, and the same DLT is detected again in the future, the DLTF 406 may follow the specified disposition and bypass the procedures outlined in 428 to 432. Additionally, the DLTF 406 may transmit the DLT state and reporting policy to an associated AF. This associated AF refers to an AF that was linked to the DLT during its provisioning process, as illustrated in FIG. 3.

At 436, the DLTF 406 may send a DLT policy update notification message to the Sensing WTRU 410 based on the DLT update performed at 434. For example, if the DLTF 406 initially determined the DLT state to be unknown at 424 and subsequently received an update from the User WTRU 408 at 434, it may send a policy update to the Sensing WTRU 410, as described at 426. The policy update ensures that the Sensing WTRU 410 aligns with the new reporting requirements for the DLT.

In one embodiment, to determine undesirable trackers near a user, a network node, which may be configured as a DLTF, may first receive a DLT reporting request from a sensing WTRU. The request may include the DDC of a DLT and the sensing WTRU detection time information, detection location information, and detection signal information.

The network node may then analyze the received DLT report. The analysis may include retrieving the DLT registration information using the received DDC. The analysis may include computing the expected DLT location based on the received detection information and previously received detection information associated with the DLT (e.g., DDC). The analysis may include obtaining information about other WTRUs/DLTs in proximity of the DLT. The analysis may include establishing a relationship between the DLT and other WTRUs/DLTs in proximity of the detected DLT. The analysis may include performing a determination of a DLT state based on the registration information, relationship and historical positioning of the DLT and other WTRUs/DLTs in proximity of the DLT. The analysis may include saving the determined DLT state information.

The network node may then send a DLT reporting response message to the sensing WTRU. The DLT reporting response message may include DDC associated with the DLT, the DLT state, and a DLT reporting policy associated with the DLT and the DLT state.

The network node may then send a DLT detection notification message to a user WTRU. The DLT detection notification message may include the user WTRU identified above and the DDC associated with a DLT, a DLT state, a current and historical DLT positioning, and a time period associated with the historical positioning.

The network node may subsequently receive a DLT detection notification response message from the user WTRU. This response message may include a disposition related to the detected DLT, such as a status confirmation and a corresponding action.

Upon receiving the disposition, the network node may process the information contained within the DLT notification. This processing may involve updating the existing DLT state information to align with the received disposition and/or reassessing whether a DLT policy update is necessary based on the revised DLT state.

The network node may then send a DLT policy update notification message to the sensing WTRU. The DLT policy update notification message notification may include the DDC associated with the DLT, the updated DLT state, and/or a DLT reporting policy associated with the DLT.

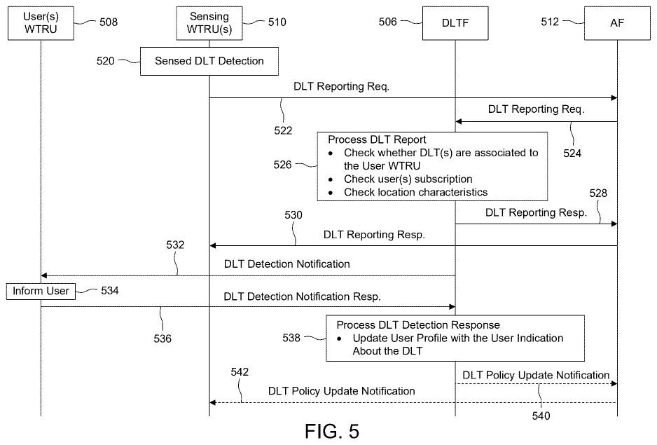

FIG. 5 provides an exemplary procedure for network detection of undesirable trackers via an associated application function (AF). An “associated AF” refers to an AF that a DLT is authorized to communicate with and report to. The DLT may receive information about its associated AF during the provisioning stage.

At 520, the Sensing WTRU 510 may detect one or more nearby DLTs using the procedure described at 420 of FIG. 4.

At 522, the Sensing WTRU 510 may send a DLT reporting request message to an associated AF 512. At 524, the AF 512 may send a DLT reporting request message to the DLTF 506. The DLT reporting request message sent by the AF 512 to the DLTF 506 may be similar to the request message received at 520. Together, the request message at 522 and the request message at 524 may be similar and achieve the same function as the request described at 422 of FIG. 4.

At 526, the DLTF 506 may process the DLT reporting request and conduct a DLT analysis, as described in 424 of FIG. 4.

At 528, the DLTF 506 may send a DLT reporting response message to the AF 512. At 530, the AF 512 may send a DLT reporting response message to the Sensing WTRU 510. The DLT reporting response message sent by the AF 512 to the Sensing WTRU 510 at 530 may be similar to the DLT reporting response message received at 528. Together, the response message at 528 and the response message at 530 may be similar and achieve the same function as the response message described at 426 of FIG. 4.

At 532, the DLTF 506, based on the analysis performed at 526, may send a DLT detection notification to the User WTRU 508 as described at 428 of FIG. 4.

At 534, the User WTRU 508 may perform actions based on the information included in the message received at 532 as described at 430 of FIG. 4.

At 536, the User WTRU 508 may send a DLT detection notification response message to the DLTF 506 as described at 432 of FIG. 4.

At 538, the DLTF 506 may update the DLT status based on the DLT detection notification response message as described at 434 of FIG. 4. The DLT status may be desirable, undesirable, or unknown.

At 540, the DLTF 506 may send a DLT policy update notification message to the AF 512. At 542, the AF 512 may send a DLT policy update notification message to the Sensing WTRU 510. The DLT policy update notification message sent by the AF 512 to the Sensing WTRU 510 may be similar to the DLT policy update notification message received by the AF 512 at 540. The DLT policy update notification message may be similar and achieve the same function as the notification described at 436 of FIG. 4.

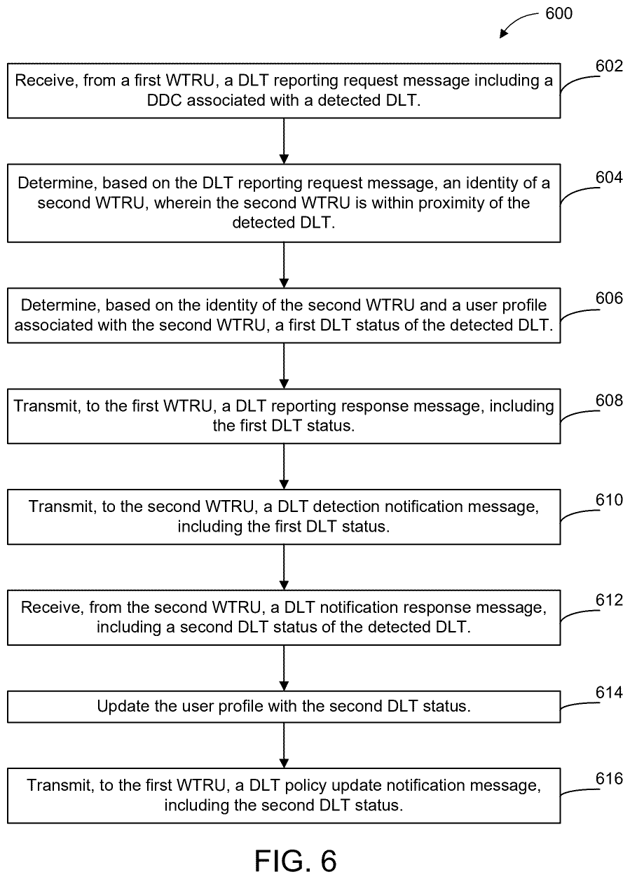

FIG. 6 illustrates a flow chart of an example procedure 600 performed by a network node for detection of undesirable trackers. The network node may be configured with a DLTF.

At 602, the network node may receive, from a first WTRU, a DLT reporting request message including a DDC associated with a detected DLT. At 604, the network node may determine, based on the DLT reporting request message, an identity of a second WTRU, wherein the second WTRU is within proximity of the detected DLT. At 606, the network node may determine, based on the identity of the second WTRU and a user profile associated with the second WTRU, a first DLT status of the detected DLT. At 608, the network node may transmit, to the first WTRU, a DLT reporting response message, including the first DLT status. At 610, the network node may transmit, to the second WTRU, a DLT detection notification message, including the first DLT status. At 612, the network node may receive, from the second WTRU, a DLT notification response message, including a second DLT status of the detected DLT. At 614, the network node may update the user profile with the second DLT status. At 616, the network node may transmit, to the first WTRU, a DLT policy update notification message, including the second DLT status. The first WTRU may be a sensing WTRU and the second WTRU may be a user WTRU. The DLT reporting request message may further include a detection time, a detection location, and detection signal information. The first DLT status may be a desirable state, an undesirable state, or an unknown state and the second DLT status may be a desirable state, an undesirable state, or an unknown state.

The example process described in FIG. 6 may further include the network node receiving information associated with other DLTs within proximity of the detected DLT and determining whether the detected DLT is associated with any WTRU within proximity of the detected DLT. On a condition that the detected DLT is not associated with any WTRU within proximity of the detected DLT, the network node may determine historical location information associated with the detected DLT, historical location information associated with other DLTs within proximity of the detected DLT, and historical location information associated with the second WTRU. The network node may then compare the historical location information associated with the detected DLT with (a) historical location information of the other DLTs or (b) historical location information associated with the second WTRU, and based on the comparison of historical location information, confirm the first DLT status of the detected DLT.

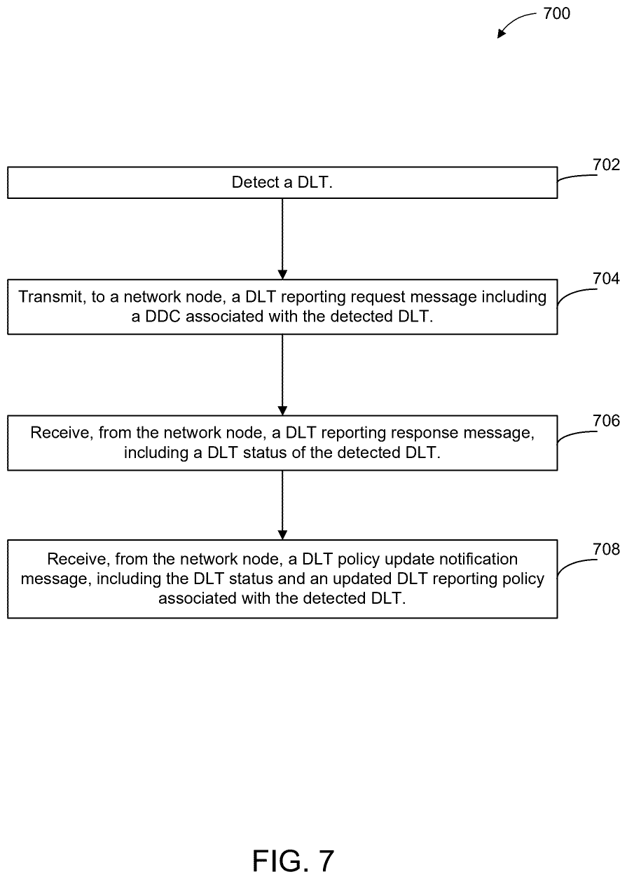

FIG. 7 illustrates a flow chart of an example procedure performed by a WTRU for detection of undesirable trackers. The WTRU may be a sensing WTRU.

At 702, the WTRU may detect a DLT. At 704, the WTRU may transmit, to a network node, a DLT reporting request message including a DDC associated with the detected DLT. The network node may be configured with a DLTF. At 706, the WTRU may receive, from the network node, a DLT reporting response message, including a DLT status of the detected DLT. At 708, the WTRU may receive, from the network node, a DLT policy update notification message, including the DLT status and an updated DLT reporting policy associated with the detected DLT. The DLT reporting request message may further include a detection time, a detection location, and detection signal information. The DLT status may be a desirable state, an undesirable state, or an unknown state.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A network node configured with a device location tracker function (DLTF), the network node comprising:
a transceiver; and
a processor;
wherein the transceiver and processor are configured to:
receive, from a first wireless transmit/receive unit (WTRU), a device with location tracking (DLT) reporting request message including a device detection code (DDC) associated with a detected DLT;
determine, based on the DLT reporting request message, an identity of a second WTRU, wherein the second WTRU is within proximity of the detected DLT;
determine, based on the identity of the second WTRU and a user profile associated with the second WTRU, a first DLT status of the detected DLT;
transmit, to the first WTRU, a DLT reporting response message, including the first DLT status;
transmit, to the second WTRU, a DLT detection notification message, including the first DLT status;
receive, from the second WTRU, a DLT notification response message, including a second DLT status of the detected DLT;
update the user profile with the second DLT status; and
transmit, to the first WTRU, a DLT policy update notification message, including the second DLT status.

2. The network node of claim 1, wherein the first WTRU is a sensing WTRU.

3. The network node of claim 1, wherein the second WTRU is a user WTRU.

4. The network node of claim 1, wherein the DLT reporting request message further includes a detection time, a detection location, and detection signal information.

5. The network node of claim 4, wherein the transceiver and processor are further configured to:
receive information associated with other DLTs within proximity of the detected DLT;
determine whether the detected DLT is associated with any WTRU within proximity of the detected DLT on a condition that the detected DLT is not associated with any WTRU within proximity of the detected DLT:
determine historical location information associated with the detected DLT, historical location information associated with other DLTs within proximity of the detected DLT, and historical location information associated with the second WTRU;
compare the historical location information associated with the detected DLT with: (a) the historical location information of the other DLTs or (b) the historical location information associated with the second WTRU; and
based on the comparison of historical location information, confirm the first DLT status of the detected DLT.

6. The network node of claim 1, wherein the transceiver and processor are further configured to:
determine, based on the DLT reporting request message, an expected location of the detected DLT.

7. The network node of claim 1, wherein the first DLT status and the second DLT status is one of a desirable state, an undesirable state, or an unknown state.

8. The network node of claim 1, wherein the DLT reporting response message further includes the DDC and a DLT reporting policy associated with at least one of the detected DLT or the first DLT status.

9. The network node of claim 1, wherein the DLT detection notification message includes the first DLT status of the detected DLT.

10. The network node of claim 1, wherein the DLT detection notification message includes a detection time and a detection location.

11. A wireless transmit/receive unit (WTRU) comprising:
a transceiver; and
a processor;
the transceiver and processor configured to:
detect a device with location tracking (DLT);
transmit, to a network node, a DLT reporting request message including a device detection code (DDC) associated with the detected DLT;
receive, from the network node, a DLT reporting response message, including a DLT status of the detected DLT; and
receive, from the network node, a DLT policy update notification message, including the DLT status and an updated DLT reporting policy associated with the detected DLT.

12. The WTRU of claim 11, wherein the WTRU is a sensing WTRU.

13. The WTRU of claim 11, wherein the network node is configured with a device location tracker function (DLTF).

14. The WTRU of claim 11, wherein the DLT reporting request message further includes a detection time, a detection location, and detection signal information.

15. The WTRU of claim 11, wherein the DLT status is one of a desirable state, an undesirable state, or an unknown state.

16. A method performed by a wireless transmit/receive unit (WTRU), the method comprising:
detecting a device with location tracking (DLT);
transmitting, to a network node, a DLT reporting request message including a device detection code (DDC) associated with the detected DLT;
receiving, from the network node, a DLT reporting response message, including a DLT status of the detected DLT; and
receiving, from the network node, a DLT policy update notification message, including the DLT status and an updated DLT reporting policy associated with the detected DLT.

17. The method of claim 16, wherein the WTRU is a sensing WTRU.

18. The method of claim 16, wherein the network node is configured with a device location tracker function (DLTF).

19. The method of claim 16, wherein the DLT reporting request message further includes a detection time, a detection location, and detection signal information.

20. The method of claim 16, wherein the DLT status is one of a desirable state, an undesirable state, or an unknown state.
